(19) United States
(12) Patent Application Publication
(10) Pub. No.: US 2020/0096808 A1
(43) Pub. Date: Mar. 26, 2020

(54) DISPLAY DEVICE AND METHOD OF PRODUCING DISPLAY DEVICE

(71) Applicant: SHARP KABUSHIKI KAISHA, Sakai City, Osaka (JP)

(72) Inventor: QINGLE XU, Sakai City, Osaka (JP)

(73) Assignee: SHARP KABUSHIKI KAISHA, Sakai City, Osaka (JP)

(21) Appl. No.: 16/495,694

(22) PCT Filed: Mar. 22, 2018
(86) PCT No.: PCT/JP2018/011284

§ 371 Date: Sep. 19, 2019

(30) Foreign Application Priority Data
Mar. 29, 2017 (JP) 2017-064784

(51) Int. Cl. G02F 1/1333; G02F 1/1335

(52) U.S. Cl. CPC G02F 1/133308; G02F 2001/133317; G02F 2202/28; G02F 1/133602

(57) ABSTRACT

A display device includes a display panel, a support member, and an adhesive member. The display panel is configured to display an image. The support member is configured to support the display panel. The adhesive member includes an adhesive surface to be adhered to the display panel. The adhesive member is integrally molded with the support member including a thermoplastic material.

### TECHNICAL FIELD

The technique disclosed in the present specification relates to a display device and a method of manufacturing the display device.

### BACKGROUND ART

Conventionally, a display device in which a display panel is fixed to a support member with an adhesive member is known. For example, in a display device including a display panel and a backlight unit, a method of adhering the display panel to a double-sided adhesive tape affixed to a frame of the backlight unit and fixing the display panel to the backlight unit has become a mainstream. Patent Document 1 below discloses a display device in which a thick double-sided tape formed of an elastic material is affixed around an opening of a middle frame of a backlight, and a display panel and the middle frame are fixed with this double-sided tape.

### RELATED ART DOCUMENT

### Patent Document

Patent Document 1: Japanese Unexamined Patent Application Publication No. 2017-21228

### Problem to be Solved by the Invention

In recent years, display devices have been designed with narrow picture frames to meet market demands. Accordingly, since the frame or the like to which the adhesive tape is affixed as described above will be narrowed, the adhesive tape itself has to be thin and small, and it is necessary to perform alignment with high precision, making it extremely difficult to perform an affixing operation of the adhesive tape to the frame or the like. As a result, the affixing operation of the adhesive tape not only takes a long time but also causes a problem that the affixed adhesive tape is likely to shift because good affixing cannot be performed, increasing defects such as generation of wrinkles, floating, and bubbles. When a display panel is affixed, a foreign substance attached to the adhesive tape, a processing burr of an end face of a protective base material (release agent, liner) protecting an adhesive surface of the adhesive tape, or the like may fall on a front surface of a light-guiding plate. These substances cannot be completely removed even after cleaning, causing a white spot of the backlight unit, deteriorating display quality of an image, and leading to generation of defects.

### DISCLOSURE OF THE PRESENT INVENTION

The technique disclosed in the present specification has been completed based on the above circumstances. It is an object of the technique to provide a display device and a method of manufacturing the display device that improve efficiency and yields of an assembly operation using an adhesive member.

### Means for Solving the Problem

The display device disclosed in the present specification has the following configurations.

(1) A display panel configured to display an image; at least one support member configured to support the display panel; and an adhesive member including an adhesive surface to be adhered to the display panel are provided. The adhesive member is integrally molded with the support member including a thermoplastic material.

In the above configuration, “integrally molded” means that a product is integrally molded simultaneously with joining of a member without using secondary bonding or mechanical joining. When the display panel includes a protective sheet, a touch panel, or the like stacked on an image display surface side, the “display panel” in the present specification includes these components.

With the above configuration, the adhesive member (for example, various tapes, spacers, or the like) is united with the support member (for example, frame or the like) by integral molding. This makes it possible to reduce the number of parts compared with a configuration in which a separately formed adhesive member is affixed to the support member, to omit an operation of affixing the adhesive member to the support member, and to increase efficiency of an assembly operation. If the adhesive member has already been integrated with the support member, the operation of affixing the display panel to the adhesive member can be easily performed, and therefore an effect of improving the efficiency of the display device assembly operation is great, and cost reduction of the assembly cost can be expected. In addition, a reduction in defects caused by attachment of foreign substances and the like when affixing the adhesive member to the support member, which has not been prevented by a conventional method, and an effect of improving yields are expected, and cost reduction is anticipated.

(2) As an aspect of the display device disclosed in the present specification, the adhesive member may include an adhesive base material with the adhesive surface formed on a front surface, and the adhesive base material may be integrally molded with the support member.

With the above configuration, while the adhesive base material is embedded and held in the support member, the adhesive surface may be disposed at a position protruding from the front surface of the support member to make it possible to perform the adhesive operation easily. Moreover, a configuration may be employed in which the adhesive member can also perform a spacer function by using the adhesive member including a thick adhesive base material.

(3) In the display device of (2) described above, the adhesive base material may include a metal.

The technique disclosed in the present specification is a technique for adhesively fixing the display panel in the display device, and in order to keep high quality of a display image, it is required to dispose the display panel in the display device with high precision. Therefore, the adhesive surface is required to have a high degree of flatness. Usually, when an adhesive member including an adhesive base material including a thin film, foamed resin, or the like is integrated as it is with a support member by a known insert molding technique or the like, there is a possibility that displacement or deformation occurs due to resin flow or injection pressure during molding, and high flatness of the adhesive surface cannot be maintained. With the above configuration, by causing the adhesive base material to include a highly rigid metal, deformation of the adhesive member during molding can be suppressed, and the flatness of the adhesive surface can be ensured. As the metal that constitutes the adhesive base material, for example, stainless steel (SUS) can be used.

(4) The display device of (1) to (3) described above may include a backlight unit configured to supply light to the display panel, and the support member may be a frame configured to support a light source in the backlight unit.

Conventionally, a display device in which a backlight unit is attached to a display panel and the display panel is fixed to a frame of the backlight unit is often used. The present technique can be preferably applied to the display device having such a configuration. In this case, the display panel can be fixed to the frame by directly adhering a back surface (surface opposite to an image display surface) or an end surface of the display panel to the adhesive surface of the adhesive member integrated with the frame.

The present specification also discloses the following method of manufacturing a display device. (5) This is a method of manufacturing a display device including: a display panel configured to display an image; at least one support member configured to support the display panel; and an adhesive member including an adhesive surface. The method includes: (a1) an adhesive member disposing process of disposing the adhesive member with the adhesive surface protected by a protective base material in a mold framework to bring the protective base material into line with an inner surface of the mold framework; (b1) a support member molding process of molding the support member with which the adhesive member is integrally molded by injecting a thermoplastic material into the mold framework in which the adhesive member is disposed; and (c1) an adhesion process of peeling the protective base material and adhesively fixing the display panel to the exposed adhesive surface.

With the above configuration, the adhesive member is integrated with the support member by insert molding. That is, prior to conventional injection molding of the support member, by only disposing the adhesive member in the mold framework, the support member with the integrated adhesive member is obtained. This makes it possible to manufacture the display device without performing the affixing operation of the adhesive member to the support member. The fixing operation of the display panel is remarkably facilitated, efficiency of the assembly operation is increased, and the manufacturing cost reduction effect can be expected. In addition, defects caused by attachment of foreign substances or the like when the adhesive member is affixed to the support member, which a conventional affixing method has failed to prevent, are reduced, and a yield improvement effect can also be expected.

(6) In the method of manufacturing a display device of (5) described above, the adhesive member may include an adhesive base material with the adhesive surface formed on a front surface, and the adhesive base material may include a metal.

With the above configuration, using the adhesive base material including a metal having higher rigidity than a resin film or paper facilitates the operation of disposing the adhesive member in the mold framework, and also suppresses deformation of the adhesive member due to pressure when the thermoplastic material is injected in the support member molding process. This makes it possible to ensure high flatness of the adhesive surface, and distortion, displacement, or the like of the display panel adhered to the adhesive surface is suppressed. Here, as the metal that constitutes the adhesive base material, for example, SUS or the like can be used.

(7) In the method of manufacturing a display device of (5) or (6) described above, the support member may have a picture frame shape in which long plate-shaped parts are combined, the adhesive member may be disposed to extend along a longitudinal direction of each of the plate-shaped parts in the support member, and in the support member molding process, when viewed in a cross section orthogonal to the longitudinal direction of each of the plate-shaped parts, the thermoplastic material may be injected from a position facing a surface on an opposite side of the adhesive member from the adhesive surface into the mold framework.

With the above configuration, in the support member molding process by insert molding, since injection pressure when the thermoplastic material is injected is received by the facing adhesive base material of the adhesive member, displacement (deviation) or twist of the adhesive member due to the injection pressure can be suppressed, and the flatness of the adhesive surface can be ensured.

(8) In the method of manufacturing a display device of (5) to (7) described above, the support member may have the picture frame shape in which the long plate-shaped parts are combined, the adhesive member may be disposed to extend along the longitudinal direction of each of the plate-shaped parts in the support member, and in the support member molding process, when viewed in the cross section orthogonal to the longitudinal direction of each of the plate-shaped parts, the thermoplastic material may be injected from a plurality of different positions into the mold framework.

With the above configuration, in the support member molding process by insert molding, it becomes possible to inject the thermoplastic material into the mold framework to offset the injection pressure, to suppress the displacement, deformation, or the like of the adhesive member, and to ensure the flatness of the adhesive surface.

The present specification also discloses the following method of manufacturing a display device. (9) A method of manufacturing a display device including: a display panel configured to display an image; at least one support member configured to support the display panel; and an adhesive member including an adhesive surface including an adhesive material. The method includes: (a2) an adhesive member molding process of molding at least a part of the adhesive member at a predetermined place in a mold framework by injecting a thermoplastic material for the adhesive member that constitutes at least a part of the adhesive member into a part of the mold framework; (b2) a support member molding process of molding the support member by injecting a thermoplastic material for the support member into a part in the mold framework excluding the predetermined place; and (c2) an adhesion process of adhering the display panel to the adhesive surface of the adhesive member after the adhesive member molding process and the support member molding process.

The above configuration can eliminate the operation of preparing the adhesive member in advance and disposing the adhesive member in the mold framework. The adhesive member molding process and the support member molding process may be performed simultaneously, or the support member molding process may be performed after the adhesive member molding process. When the adhesive member includes the adhesive base material with the adhesive surface formed on the front surface, an adhesive base material molding process of molding the adhesive base material by injecting the material constituting the adhesive base material, or an adhesive base material disposing process of disposing the adhesive base material molded in advance in the mold framework may further be included.

The present specification also discloses the following method of manufacturing a display device. (10) A method of manufacturing a display device including: a display panel configured to display an image; at least one support member configured to support the display panel; and an adhesive member including an adhesive base material and an adhesive surface formed on a front surface of the adhesive base material. The method includes: (a3) a support member molding process of molding the support member including a recess part by injecting a thermoplastic material for the support member into a mold framework for the support member; (b3) an adhesive base material molding process of molding the adhesive base material with at least a part being fixed in the recess part by injecting a thermoplastic material for the adhesive base material into a mold framework for the adhesive base material obtained by replacing at least a part of the mold framework for the support member; (c3) an adhesive surface forming process of forming the adhesive surface by disposing an adhesive material on the front surface of the adhesive base material; and (d3) an adhesion process of adhering the display panel to the adhesive surface.

With the above configuration, the support member in which at least a part of the adhesive member is fixed can be molded by performing injection molding in two stages, while avoiding displacement or deformation of the adhesive member due to injection pressure when injection molding of the support member is performed, and ensuring the flatness of the adhesive surface.

### Advantageous Effect of the Invention

The technique disclosed in the present specification can provide a display device and a method of manufacturing the display device that improve the efficiency of the assembly operation and improve the yields of the display device.

### BRIEF DESCRIPTION OF THE DRAWINGS

FIG. 1 is an exploded perspective view showing a schematic configuration of a liquid crystal display device according to a first embodiment.

FIG. 2 is a cross-sectional view showing a cross-sectional configuration along a short side direction of the liquid crystal display device.

FIG. 3 is a plan view of a frame provided in a backlight device (with a protective base material peeled).

FIG. 4 is a cross-sectional view taken along the line A-A in FIG. 3.

FIG. 5 is a cross-sectional view schematically showing a support member molding process in one example of a manufacturing method.

FIG. 6 is a cross-sectional view schematically showing a support member molding process in a modification of the first embodiment.

FIG. 7 is a cross-sectional view schematically showing an adhesive member molding process and a support member molding process according to a second embodiment.

FIG. 8 is a cross-sectional view schematically showing a support member molding process according to a third embodiment.

FIG. 9 is a cross-sectional view schematically showing an adhesive base material molding process.

### MODES FOR CARRYING OUT THE INVENTION

### First Embodiment

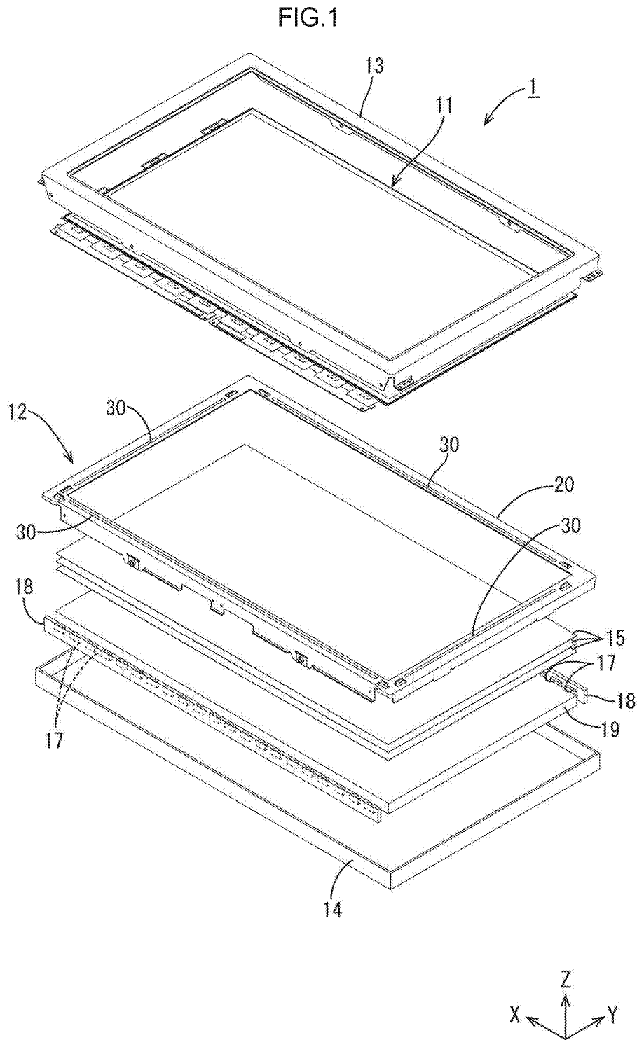

The first embodiment will be described with reference to FIGS. 1 to 6. The present embodiment illustrates a liquid crystal display device (display device) 1. Note that an X-axis, a Y-axis, and a Z-axis are shown in part of each drawing, and are drawn such that each axial direction is a direction shown in each drawing. An upper side in FIG. 1 is a front side (lower side is a back side). One member of a plurality of identical members is denoted with a reference symbol, and a reference symbol may be omitted for the other members.

As shown in FIG. 1, the liquid crystal display device 1 according to the present embodiment has an oblong (longitudinal) square shape (rectangular shape) as a whole, and includes a liquid crystal panel 11, which is a display panel, and a backlight device (backlight unit) 12, which is an external light source. These components are integrally held by a framework-shaped bezel 13 or the like.

Details of the liquid crystal panel 11 are not shown. The liquid crystal panel 11 with a pair of glass substrates bonded together with a predetermined gap and a liquid crystal sealed between the glass substrates can be used. On one glass substrate, switching elements (for example, TFT) connected to source lines and gate lines orthogonal to each other, pixel electrodes connected to the switching elements, furthermore an alignment film, and the like are provided. On the other glass substrate, a color filter in which colored portions such as R (red), G (green), and B (blue) are arranged in a predetermined arrangement, counter electrodes, furthermore an alignment film, and the like are provided. Note that polarizing plates are disposed outside both substrates. The liquid crystal panel 11 is disposed in a posture in which a normal direction of a plate surface of the liquid crystal panel 11 agrees with a Z-axis direction.

A schematic configuration of the backlight device 12 will be described. As shown in FIG. 1, the backlight device 12 has an outline of a rectangular shape in plan view, and is a so-called edge light type (side light type) in which light emitting diodes (LEDs) 17, which are light sources, are arranged along a side edge of a light-guiding plate 19 disposed inside the backlight device 12.

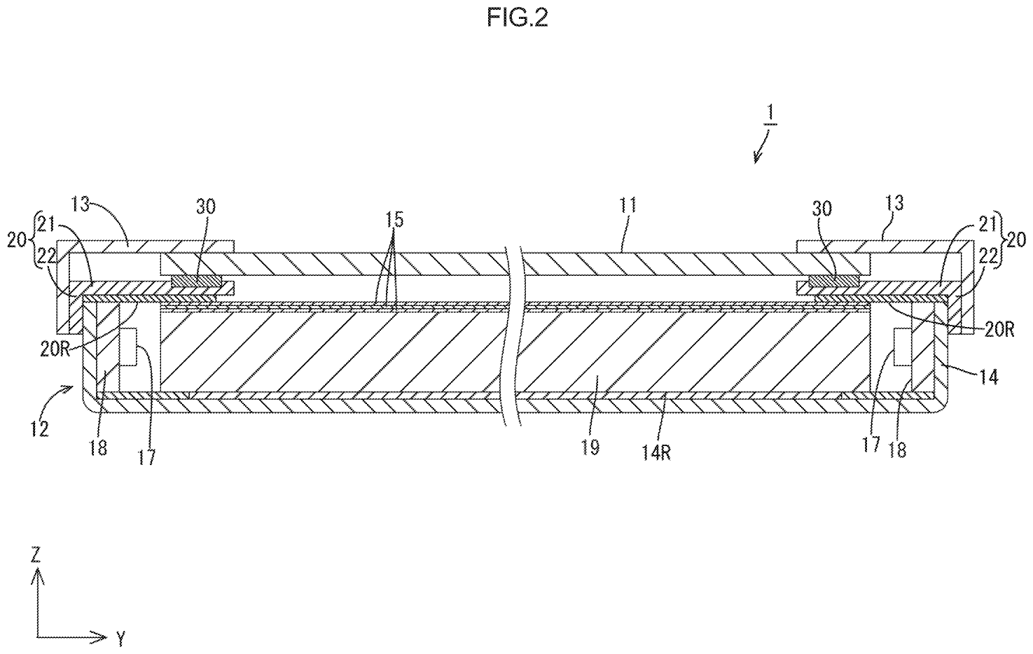

As shown in FIGS. 1 and 2, the backlight device 12 includes a substantially box-shaped chassis 14 that opens to the front side, that is, to a light emission side (liquid crystal panel 11 side). Substrates such as a control board and an LED drive circuit board (not shown) are attached to the back side of a bottom plate of the chassis 14, and a chassis side reflection sheet 14R (see FIG. 2) is disposed on the front side. The chassis side reflection sheet 14R has a function of reflecting light emitted to the back side of the light-guiding plate 19 described later toward the front side and emitting the light from the front side (light emission side).

In the chassis 14, LED substrates (light source substrates) 18 on which the LEDs 17 are mounted and the light-guiding plate 19 are housed. In the backlight device 12, the LED substrates 18 including the LEDs 17 are disposed in a pair on both ends on the long side along the X-axis. The LED substrates 18 forming a pair sandwich the light-guiding plate 19 from both sides of a short side direction (Y-axis direction).

The LEDs 17 mounted on each LED substrate 18 are of a so-called top-emitting type, and are unevenly distributed near each end on the long side of the liquid crystal panel 11. Groups each including a plurality of the LEDs 17 are arranged side by side at intervals in a direction along the end, that is, along the long side direction (X-axis direction).

The light-guiding plate 19 includes an almost transparent (excellent in translucency) synthetic resin material (for example, acrylic resin such as PMMA) having a refractive index sufficiently higher than a refractive index of air. The light-guiding plate 19 has a function of introducing light emitted from the LEDs 17 along the Y-axis direction from end surfaces of the long side, rising the light along the Z-axis direction toward the liquid crystal panel 11 side (front side, light emission side, optical member 15 side described later) while propagating the light inside the light-guiding plate 19, and emitting the light from the plate surface.

The optical members 15 are stacked on the front side (light emission side) of the light-guiding plate 19 and are disposed so as to be interposed between the liquid crystal panel 11 and the light-guiding plate 19. The optical members 15 are obtained by stacking a plurality of (three in the present embodiment) sheet-shaped members appropriately selected from, for example, a diffusion sheet, a lens sheet, a reflective polarizing sheet, or the like. The optical members 15 have a function of transmitting the light emitted from the light-guiding plate 19 and emitting the light toward the liquid crystal panel 11 while giving a predetermined optical action to the transmitted light.

Each of the above-described members is pressed from the front side and held in the chassis 14 by a frame 20 and the bezel 13 being fixed to a side plate of the chassis 14 with screws or the like (not shown) (see FIG. 2).

Next, the frame (support member) 20 will be described. The frame 20 is formed by injection molding of a polycarbonate (PC) resin, an acrylonitrile butadiene styrene (ABS) resin, or the like. In the present embodiment, a white frame is used as the frame 20, but a black frame may be used from a viewpoint of suppressing light leakage to the outside. As shown in FIGS. 1 to 3, the frame 20 has a thin rectangular framework shape (rectangular framework shape, picture frame shape) capable of fitting outer peripheral ends of the optical members 15 stacked on the light-guiding plate 19. The frame 20 is disposed to open toward both sides (front side and back side) in the Z-axis direction.

The frame 20 includes a front framework part 21 disposed along outer peripheral edges of front surfaces of the optical members 15, and a side framework part 22 protruding from an outer peripheral end of the front framework part 21 toward the back side. The front framework part 21 is disposed such that long framework parts 21a extend along the X-axis direction and short framework parts 21b extend along the Y-axis direction in accordance with the light-guiding plate 19 and the optical members 15. The side framework part 22 is formed to extend from the outer peripheral end of each of the long framework parts 21a and the short framework parts 21b to the back side (optical members 15 and light-guiding plate 19 side) along the Z-axis direction. As described above, in a state where a back surface of the front framework part 21 is in contact with the entire outer peripheral ends of front surfaces of the optical members 15 and presses the light-guiding plate 19 and the optical members 15, the side framework part 22 is fixed to the side plate of the chassis 14 as described above.

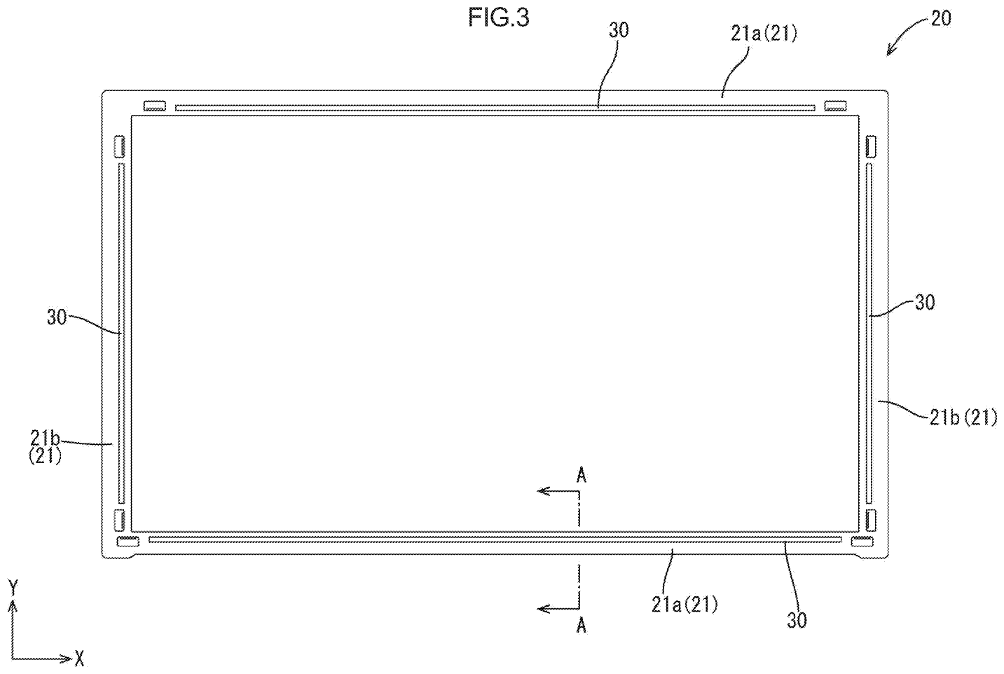

As shown in FIG. 3 and other figures, adhesive members 30 described later are integrally formed on a front surface of the front framework part 21. A back surface of the liquid crystal panel 11 is adhesively fixed to the adhesive members 30, and the frame 20 supports the liquid crystal panel 11 from the back surface. A frame-side reflection sheet 20R that reflects light is attached to the back surface of the front framework part 21, that is, to a surface facing the optical members 15 (light-guiding plate 19) and the LED substrates 18 (LEDs 17), as shown in FIG. 2. The frame-side reflection sheet 20R is formed in a size extending substantially over the entire length in the longitudinal direction of the long framework part 21a of the front framework part 21, and covers an upper end of the light-guiding plate 19 and an upper part of the LEDs 17 from the front side.

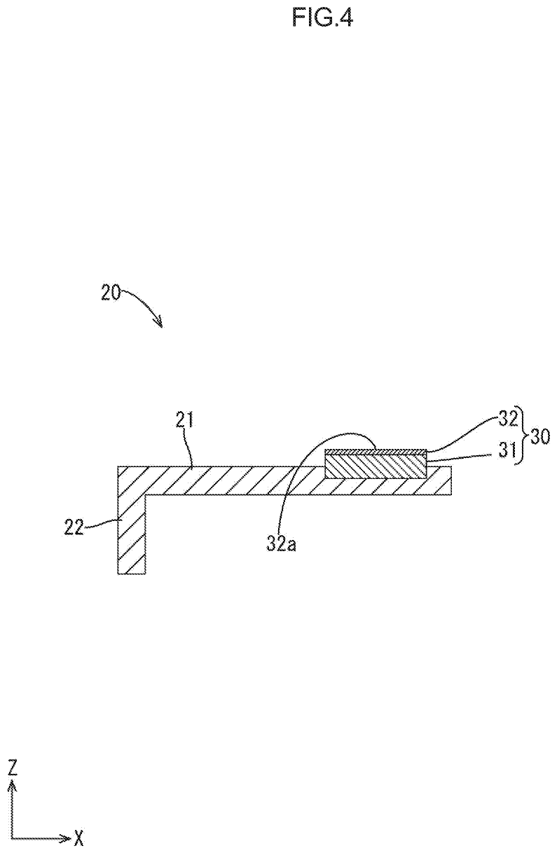

Next, each of the adhesive members 30 will be described. As shown in FIG. 4, the adhesive member 30 includes an adhesive base material 31 and an adhesive layer 32 formed on the adhesive base material 31, and is integrally molded with the frame 20.

In the present embodiment, the adhesive base material 31 including stainless steel (SUS) is used. Conventionally, as an adhesive base material such as a double-sided tape, a polyester film including PET, a nonwoven fabric, a foamed resin, and the like are often used. Although these adhesive base materials can also be used, in the present embodiment, by using SUS having high heat resistance and high rigidity, the entire adhesive member 30 is provided with stiffness and is not easily deformed. In the present embodiment, as shown in FIG. 4, apart of the adhesive base material 31 is embedded in the front framework part 21 of the frame 20 when viewed in a cross section, and the adhesive layer 32 is disposed at a position slightly protruding from the front surface of the frame 20. As shown in FIG. 3, the adhesive member 30 is integrally molded to extend in a longitudinal direction in each of the long framework part 21a and the short framework part 21b of the front framework part 21 in plan view.

As the adhesive layer 32, an acrylic-based adhesive, a silicone-based adhesive, a rubber-based adhesive, and the like, which are usually used as an adhesive for panel adhesion, can be used. Among these adhesives, an adhesive excellent in heat resistance can be preferably used. A front surface of the adhesive layer 32 is an adhesive surface 32a.

A protective base material (release agent, liner) 33 may be affixed on the adhesive surface 32a until the liquid crystal panel 11 is adhered. As the protective base material 33, a siliconized flat paper, a polyester film, or the like, which are usually used for a double-sided tape or the like, can be used. Among these materials, a protective base material excellent in heat resistance can be preferably used.

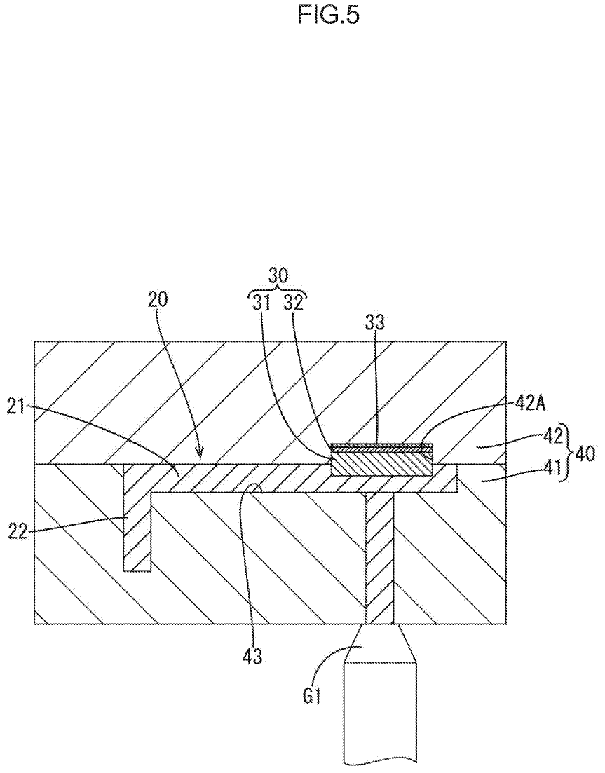

Subsequently, one example of a method of manufacturing the liquid crystal display device 1 having the above configuration according to the present embodiment will be described with reference to FIG. 5. Note that FIG. 5 is a diagram schematically showing a cross section orthogonal to the longitudinal direction of the long framework part 21a and the short framework part 21b of the frame 20. The liquid crystal display device 1 is manufactured by a method including (a1) an adhesive member disposing process, (b1) a frame molding process (support member molding process), and (c1) an adhesion process. Each process will be described in order below.

(a1) In the adhesive member disposing process, in a state where the protective base material 33 is affixed to the adhesive surface 32a of the adhesive member 30 prepared in advance, the adhesive member 30 is disposed in a mold framework 40. As shown in FIG. 5, the mold framework 40 according to the present embodiment includes a rear framework 41 and a front framework 42, and when both the frameworks 41 and 42 are united, a cavity 43 for molding the frame 20 therewithin is formed. The front framework 42 is provided with a groove part 42A recessed upward in FIG. 5. The adhesive member 30 is fitted and disposed in the groove part 42A such that the protective base material 33 is in contact with an inner surface of the groove part 42A. In the present embodiment, the groove part 42A has a size in which part of the protective base material 33, the adhesive layer 32, and the adhesive base material 31 out of the adhesive member 30 is fitted, and is set such that the adhesive member 30 is unlikely to be displaced or deformed in the cavity 43.

(b1) The frame molding process is performed following the above adhesive member disposing process. In the frame molding process, after the adhesive member 30 is disposed in the groove part 42A as described above, the front framework 42 and the rear framework 41 are united, and mold clamping is performed. A thermoplastic material that constitutes the frame 20 is injected into the cavity 43 formed inside the mold framework 40.

At this time, in order to secure flatness of the adhesive surface 32a to which the liquid crystal panel 11 is to be fixed later, it is preferable to suppress displacement, deformation, or the like of the adhesive member 30 as much as possible. For that purpose, it is desired to appropriately adjust the temperature of the mold framework 40 or the like when the thermoplastic material is injected, viscosity, injection speed, and pressure of the thermoplastic material, disposition of a gate G1 that injects the thermoplastic material into the mold framework 40, or the like. Although molding conditions differ depending on the materials to use or the like, integral molding of the adhesive base material 31 including SUS and the frame 20 can be implemented where, for example, the metal mold temperature is from 80° C. to 120° C., the injection speed is from 300 mm/s to 800 mm/s, and the pressure is from 800 Mpa to 1100 Mpa. In the present embodiment, the gate G1 is provided at a position along a central line of the groove part 42A of the front framework 42 and facing the groove part 42A on the rear framework 41 when viewed in the cross section shown in FIG. 5.

Note that FIG. 5 is drawn such that the front framework 42 is disposed vertically upward and the rear framework 41 is disposed downward, but there is no need that the mold framework 40 is always maintained in such a posture during this process. While avoiding displacement of the adhesive member 30 in the cavity 43, considering the flow of the thermoplastic material to be injected or the like, an adjustment may be made such that, for example, in an initial stage, a posture is adopted in which a region of the cavity 43 that constitutes the side framework part 22 drawn on the left side of FIG. 5 is disposed substantially downward, and in a stage where the region is filled with the thermoplastic material to some extent, counterclockwise rotation is slowly made in FIG. 5, and a region that constitutes the front framework part 21 including a far side of the adhesive base material 31 is filled with the thermoplastic material, without any gap.

As described above, in the frame molding process, the frame 20 with which the adhesive member 30 is integrated is molded. A part of the adhesive member 30 fitted into the groove part 42A of the front framework 42 is disposed at a position slightly protruding from the front surface of the frame 20.

(c1) The adhesion process is performed after the frame molding process. In the adhesion process, the protective base material 33 is peeled from the adhesive member 30 integrally molded with the frame 20, and the liquid crystal panel 11 is adhered to the exposed adhesive surface 32a.

After the frame 20 is molded, the rear framework 41 and the front framework 42 are separated from each other, and mold opening for removing the mold framework 40 is performed. The adhesive surface 32a of the adhesive member 30 integrally molded with the frame 20 is maintained in a state where the protective base material 33 is affixed and the adhesive surface 32a is protected. The adhesion process may be performed subsequent to the mold opening, or may be performed with another process or the like interposed therebetween. In an appropriate stage, the liquid crystal panel 11 is fixed to and supported by the frame 20 by peeling the protective base material 33 and adhering the liquid crystal panel 11 to the adhesive surface 32a.

The liquid crystal display device 1 according to the present embodiment as described above provides the following effects. According to the present embodiment, the adhesive member 30 is united with the frame 20 of the backlight device 12 by integral molding. Therefore, when compared with a configuration in which an adhesive tape formed separately is affixed to the frame 20, the number of parts can be reduced, and an affixing operation of the adhesive tape to the frame 20 can be omitted to reduce the assembly man-hour, and efficiency of the assembly operation can be improved. Since the adhesive member 30 is integrated with the frame 20 in advance and the liquid crystal panel 11 can be easily affixed, the effect of improving the efficiency of the assembly operation of the liquid crystal display device 1 is great, and reduction in assembly costs can be expected. In addition, defects caused by attachment of foreign substances when the adhesive tape is affixed to the frame 20, which have been a problem in a conventional method, are suppressed, and the yield improvement effect can also be expected.

According to the present embodiment, a part of the adhesive base material 31 of the adhesive member 30 is integrally molded with the front framework part 21 of the frame 20. Therefore, the adhesive surface 32a is disposed at a position protruding from the front surface of the front framework part 21 while the adhesive base material 31 is embedded and held in the frame 20, making it possible to performing the adhesion operation more easily.

According to the present embodiment, the adhesive member 30 is integrally molded with the frame 20 of the backlight device 12. Conventionally, a lot of display devices each including a liquid crystal panel and a backlight device have been used, and the present technique is preferably applicable to such a device by fixing the liquid crystal panel 11 to the frame 20 of the backlight device 12.

According to the present embodiment, the adhesive member 30 is integrated with the frame 20 by insert molding. By simply disposing the adhesive member 30 in the mold framework 40 before the conventional injection molding of the frame 20, the frame 20 with which the adhesive member 30 is integrated can be obtained.

According to the present embodiment, the adhesive base material 31 includes SUS. By using a material including SUS (metal) having higher rigidity than conventional resin films or paper as the adhesive base material 31, the operation of disposing the adhesive member 30 in the mold framework 40 becomes easy, and in the frame molding process, deformation of the adhesive member 30 caused by injection pressure or resin flow when the thermoplastic material is injected is suppressed. This makes it possible to ensure high flatness of the adhesive surface 32a, and distortion, displacement, or the like of the liquid crystal panel 11 adhered to the adhesive surface 32a is suppressed.

According to the present embodiment, the gate G1 that injects the thermoplastic material in the frame molding process is provided at a position along the central line of the groove part 42A of the front framework 42 and facing the groove part 42A on the rear framework 41 when viewed in the cross section shown in FIG. 5. Therefore, since injection pressure when the thermoplastic material is injected is received by the facing adhesive base material 31, displacement (deviation) or twist of the adhesive member 30 caused by the injection pressure is suppressed, making it easy to secure the flatness of the adhesive surface 32a.

### First Modification of First Embodiment

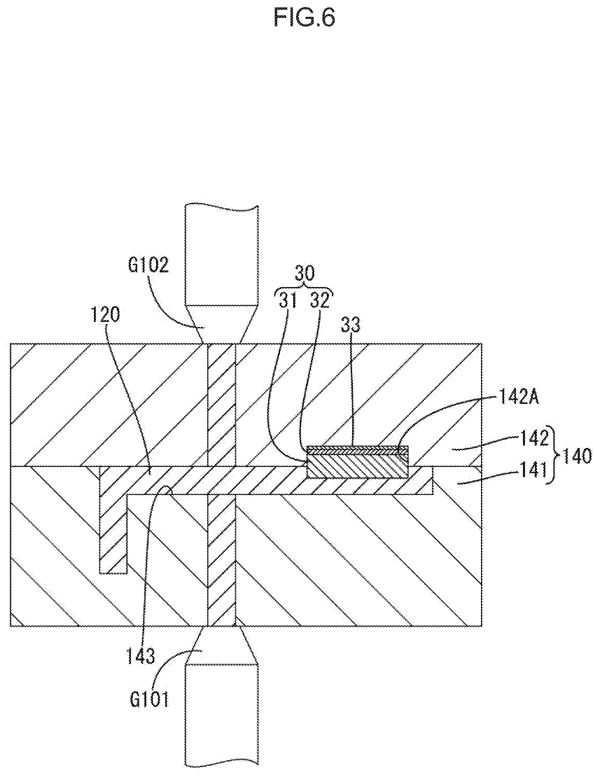

A first modification of the first embodiment will be described with reference to FIG. 6. A frame 120 according to the present first modification differs from the frame 20 of the first embodiment in a position of a gate in (b1) the frame molding process related to manufacturing thereof. Since other configurations are similar to configurations of the first embodiment, members similar to members of the first embodiment described above are denoted with the same reference symbols, and redundant descriptions of operations and effects will be omitted (this will be similarly applied to the second embodiment and after).

A mold framework 140 used for manufacturing the frame 120 includes a rear framework 141 and a front framework 142, and in FIG. 6 showing a cross section similar to FIG. 5, gates G101 and G102 are provided at two locations. As in the first embodiment, an adhesive member 30 to which a protective base material 33 is affixed is fitted in advance into a groove part 142A provided in the front framework 142. Both of the two gates G101 and G102 inject a thermoplastic material that constitutes the frame 120, and both of the gates G101 and G102 are disposed to face each other with a cavity 143 interposed therebetween. In order to mold the frame 120, for example, the thermoplastic material can be injected from both of the gates G101 and G102 while adjusting pressure to fill the cavity 143 from both sides of the adhesive member 30. Note that in the present modification as well, as in the first embodiment, a posture of the mold framework 140 may be changed as appropriate.

According to the present first modification, in the frame molding process by insert molding of the adhesive member 30, a plurality of the gates G101 and G102 is provided at positions facing each other with the cavity 143 interposed therebetween. This makes it possible to inject the thermoplastic material into the cavity 143 such that injection pressure from both of the gates G101 and G102 is offset, and to secure flatness of an adhesive surface 32a by suppressing displacement, deformation, or the like of the adhesive member 30.

### Second Embodiment

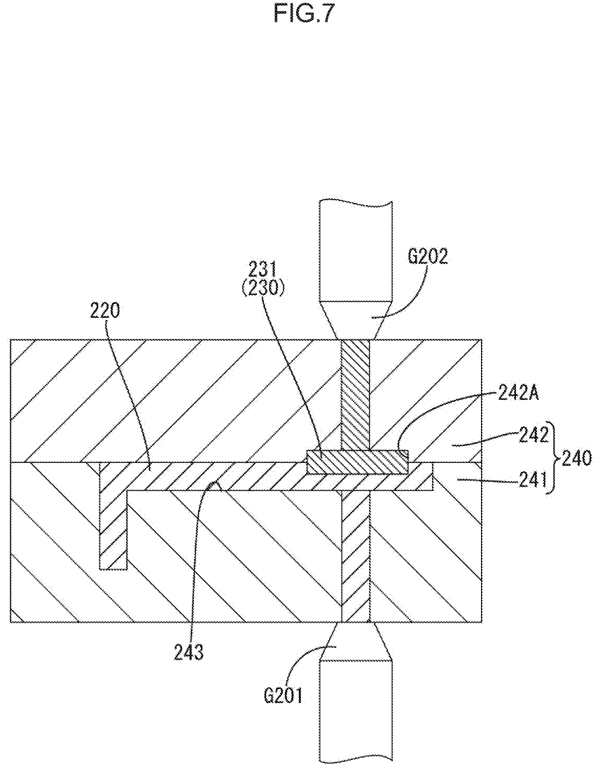

The second embodiment will be described with reference to FIG. 7. A frame 220 according to the present second embodiment is different from the frame 20 according to the first embodiment in a manufacturing method thereof. The frame 220 is molded by a method including (a2) an adhesive member molding process and (b2) a frame molding process (support member molding process).

(a2) In the adhesive member molding process, a thermoplastic material for an adhesive member that constitutes at least part of an adhesive member 230 is injected into part of a mold framework 240 to mold at least part of the adhesive member 230 in a predetermined region in the mold framework 240. The mold framework 240 used for manufacturing the frame 220 according to the present embodiment includes a rear framework 241 and a front framework 242, and a groove part 242A is provided in the front framework 242. In FIG. 7 showing a cross section similar to FIG. 5, a gate G202 is provided at a position communicating with the groove part 242A, and a gate G202 is provided at a position facing the gate G202 with a cavity 243 interposed therebetween. A thermoplastic material for a frame that constitutes the frame 220 is injected from the gate G202. From a gate G201, the thermoplastic material for an adhesive member that constitutes at least part of the adhesive member 230 is injected toward a region near the groove part 242A in a cavity 143.

The adhesive member 230 according to the present embodiment includes an adhesive base material 231 with an adhesive surface including an adhesive layer formed on a front surface, in a similar manner to the adhesive member 30 of the first embodiment. FIG. 7 schematically illustrates a process of molding the adhesive base material 231 by injecting the thermoplastic material for an adhesive base material that constitutes the adhesive base material 231 from the gate G202 (adhesive base material molding process). By appropriately adjusting a temperature of the mold framework 240, viscosity, injection pressure, or the like of the thermoplastic material when injecting the thermoplastic material for an adhesive base material, the adhesive base material 231 is molded in a predetermined region near the groove part 242A.

Although not shown, in a state where the adhesive base material 231 is molded to some extent, leaving a slight gap on the front side of the groove part 242A, the material to be injected from the gate G202 may be changed from the thermoplastic material for an adhesive base material to an adhesive thermoplastic material that constitutes an adhesive layer, and the adhesive layer may be molded on the front surface of the adhesive base material 231 (adhesive layer forming process). Alternatively, after the mold framework 240 is opened, application may be performed by a well known method such as a bar coater or a roll coater. Since the adhesive base material 231 is molded to slightly protrude from the front surface of the frame 220, an adhesive material can be easily applied to the front surface.

Note that the adhesive surface of the adhesive layer front surface is preferably protected by a protective base material until an adhesion process to be performed after this process. The protective base material may be affixed to the adhesive surface after the mold framework 240 is opened and the frame 220 with which the adhesive member 230 is integrally molded is removed from the mold framework 240. Alternatively, when the above-described adhesive layer forming process is performed, the protective base material may be affixed or the like in advance on the front surface of the groove part 242A to provide protection simultaneously with formation of the adhesive layer.

(b2) In the frame molding process, in the cavity 243 of the mold framework 240, the thermoplastic material for a frame is injected from the gate G201 to a portion excluding a predetermined region where the adhesive member 230 is molded to mold the frame 220. By appropriately adjusting the temperature of the mold framework 240, the viscosity, the injection pressure, or the like of the thermoplastic material when injecting the thermoplastic material for a frame, the cavity 243 excluding the predetermined region near the groove part 242A is filled with the thermoplastic material for a frame and the frame 220 is molded.

(a2) the adhesive member molding process and (b2) the frame molding process may be performed simultaneously, or (b2) the frame molding process may be performed after (a2) the adhesive member molding process.

As described above, after the frame 220 with which the adhesive member 230 is integrated is molded, (c2) the adhesion process is performed, and the liquid crystal panel 11 is adhered to the adhesive surface of the adhesive member 230. As described above, when the protective base material is disposed on the adhesive surface for protection, the protective base material is peeled, and the liquid crystal panel 11 is adhered to the exposed adhesive surface.

The above configuration makes it possible to eliminate the operation of preparing the adhesive member in advance and disposing the adhesive member inside the mold framework.

### Third Embodiment

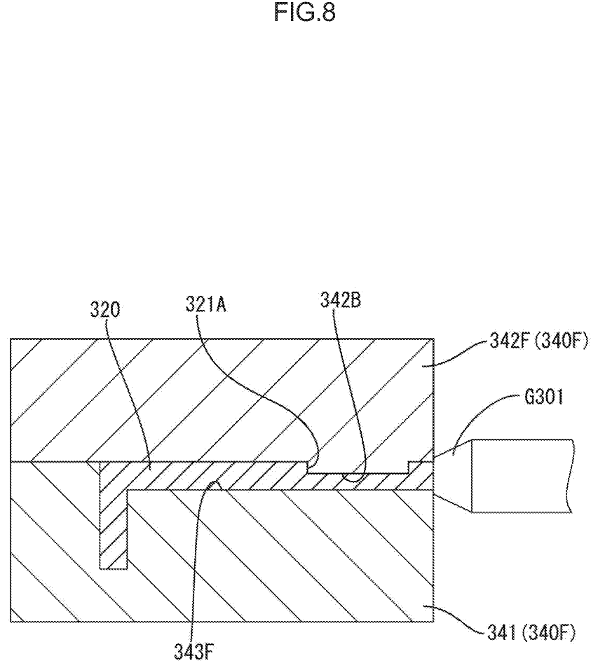

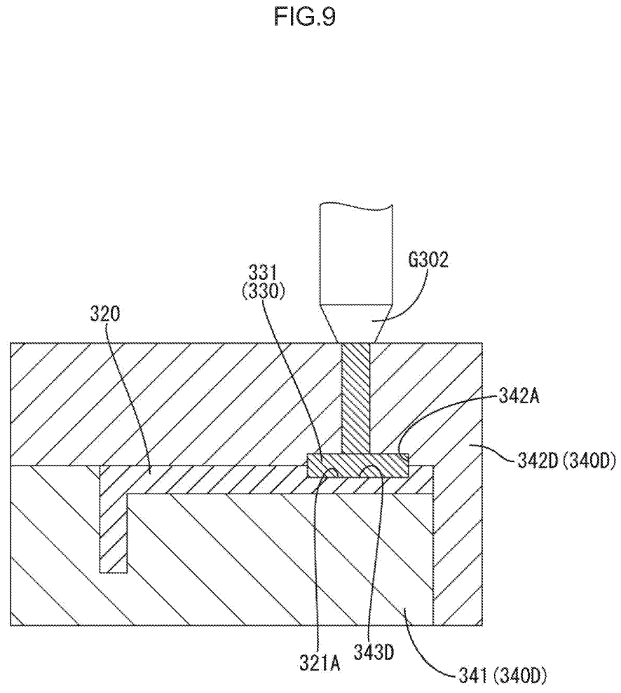

The third embodiment will be described with reference to FIGS. 8 and 9. A frame 320 according to the present third embodiment is different from the frame 20 according to the first embodiment in a manufacturing method thereof. The frame 320 is molded by a method including (a3) a frame molding process (support member molding process), (b3) an adhesive base material molding process, and (c3) an adhesive surface forming process.

(a3) In the frame molding process, a thermoplastic material for a frame is injected into a mold framework for a frame (mold framework for a support member) to mold the frame 320 including a recess part 321A. In the present embodiment, a mold framework that is partially replaced is used. For a mold framework for a frame 340F, as shown in FIG. 8, a rear framework 341 and a front framework for a frame 342F are used in combination. In the front framework for a frame 342F, a ridge 342B protruding downward in FIG. 8 is formed. The rear framework 341 and the front framework for a frame 342F are united, and mold clamping is performed. The thermoplastic material for a frame is injected from a gate G301 into a cavity for a frame 343F formed inside the mold framework for a frame 340F. Therefore, the frame 320 with the recess part 321A formed at a location corresponding to the ridge 342B is obtained.

(b3) The adhesive base material molding process is performed following the frame molding process. In the adhesive base material molding process, a thermoplastic material for an adhesive base material is injected into the recess part 321A to mold an adhesive base material 331, at least part of which is fixed in the recess part 321A. In the present embodiment, out of the mold framework for a frame 340F, the front framework for a frame 342F is replaced with a front framework for an adhesive base material 342D for use as a mold framework for an adhesive base material 340D. While the molded frame 320 is held in the rear framework 341, the front framework for a frame 342F is replaced with the front framework for an adhesive base material 342D. In the front framework for a frame 342F, a groove part 342A that is recessed upward in FIG. 9 is provided at a position facing the recess part 321A of the frame 320, and a cavity for an adhesive base material 343D is formed between the recess part 321A and the groove part 342A. The thermoplastic material for an adhesive base material is injected from a gate G302 provided to communicate with the recess part 321A into the cavity for an adhesive base material 343D. Therefore, the adhesive base material 331, part of which is fixed to the recess part 321A, is obtained.

(c3) The adhesive surface forming process is performed following the adhesive base material molding process. In the adhesive surface forming process, an adhesive surface is formed by disposing an adhesive layer including an adhesive material on the front surface of the adhesive base material 331 that is integrally molded with the frame 320. A method of disposing the adhesive layer is not particularly limited. As in the second embodiment, the material to be injected into the cavity for an adhesive base material 343D may be switched at some midpoint from a thermoplastic resin for an adhesive base material to an adhesive thermoplastic material that constitutes the adhesive layer. After mold opening of the mold framework for an adhesive base material 340D is performed, application may be performed by a well known method. Alternatively, as in the second embodiment, a protective base material may be affixed on the adhesive surface of the adhesive layer.

As described above, after the frame 320 with which an adhesive member 330 is integrated is molded, (d3) an adhesion process is performed, and a liquid crystal panel 11 is adhesively fixed to the adhesive surface of the adhesive member 330.

With the above configuration, by performing injection molding in two stages, the adhesive member 330 having a desired shape can be integrally molded easily at a desired position of the frame 320. That is, while displacement or deformation of the adhesive member 330 caused by injection pressure when the frame 320 is molded is avoided and flatness of the adhesive surface is ensured, the frame 320 to which part of the adhesive base material 331 is fixed can be molded.

### Other Embodiments

The technique disclosed in the present specification is not limited to the embodiments described with reference to the above descriptions and the drawings. For example, the following embodiments are also included in the technical scope. (1) In the above embodiments, an interface between the adhesive base material and the frame may be formed to exhibit an uneven shape. By causing the frame and the adhesive base material to be complicatedly intertwined, for example, in a wedge shape or the like at the interface, the adhesive base material and the frame are more firmly fixed, making it possible to prevent the adhesive member from falling off. For example, in the above first embodiment, such a structure can be easily obtained by processing the back side of the base material of the adhesive member 30 and then disposing the adhesive member 30 in the mold framework 40. (2) In the above embodiments, the influence of injection pressure or resin flow during insert molding can be suppressed by devising an interface shape between the adhesive base material and the frame. For example, if corners of the adhesive base material are chamfered in advance, the thermoplastic resin for a frame easily spreads uniformly around the adhesive base material. (3) In the above second embodiment, the adhesive layer may be formed on the front surface side of the adhesive base material 231 by disposing the adhesive base material 231 molded in advance such that a part thereof is fitted into the groove part 242A in the cavity 243 and injecting the adhesive thermoplastic material that constitutes the adhesive layer from the gate G202. (4) The support member may be a bezel that supports a peripheral edge of the display panel. Affixing the adhesive member to the bezel under great influence of narrow picture frame can be omitted. (5) In each of the above embodiments, the liquid crystal display device using a liquid crystal panel as the display panel has been exemplified. However, the present technique can be applied to display devices using other types of display panel.

### EXPLANATION OF SYMBOLS

1: liquid crystal display device (display device)
11: liquid crystal panel (display panel)
12: backlight device (backlight unit)
20: frame (support member)
21: front framework part
21a: long framework part
21b: short framework part
22: side framework part
30: adhesive member
31: adhesive base material
32: adhesive layer
32a: adhesive surface
33: protective base material (release agent, liner)
40: mold framework
41: rear framework
42: front framework
42A: groove part
43: cavity
G1: gate

1. A display device comprising:
a display panel configured to display an image;
at least one support member configured to support the display panel; and
an adhesive member including an adhesive surface to be adhered to the display panel,
wherein the adhesive member is integrally molded with the support member including a thermoplastic material

2. The display device according to claim 1, wherein
the adhesive member includes an adhesive base material with the adhesive surface formed on a front surface, and
the adhesive base material is integrally molded with the support member.

3. The display device according to claim 2, wherein the adhesive base material includes a metal.

4. The display device according to claim 1, further comprising a backlight unit configured to supply light to the display panel,
wherein the support member is a frame configured to support a light source in the backlight unit.

5. A method of manufacturing a display device including:
a display panel configured to display an image;
at least one support member configured to support the display panel; and
an adhesive member including an adhesive surface,
the method comprising:
(a1) an adhesive member disposing process of disposing the adhesive member with the adhesive surface protected by a protective base material in a mold framework to bring the protective base material into line with an inner surface of the mold framework;
(b1) a support member molding process of molding the support member with which the adhesive member is integrally molded by injecting a thermoplastic material into the mold framework in which the adhesive member is disposed; and
(c1) an adhesion process of peeling the protective base material and adhesively fixing the display panel to the exposed adhesive surface.

6. The method of manufacturing a display device according to claim 5, wherein
the adhesive member includes an adhesive base material with the adhesive surface formed on a front surface, and
the adhesive base material includes a metal.

7. The method of manufacturing a display device according to claim 5, wherein
the support member has a picture frame shape in which long plate-shaped parts are combined,
the adhesive member is disposed to extend along a longitudinal direction of each of the plate-shaped parts in the support member, and
in the support member molding process, when viewed in a cross section orthogonal to the longitudinal direction of each of the plate-shaped parts, the thermoplastic material is injected from a position facing a surface on an opposite side of the adhesive member from the adhesive surface into the mold framework.

8. The method of manufacturing a display device according to claim 5, wherein
the support member has the picture frame shape in which the long plate-shaped parts are combined,
the adhesive member is disposed to extend along the longitudinal direction of each of the plate-shaped parts in the support member, and
in the support member molding process, when viewed in the cross section orthogonal to the longitudinal direction of each of the plate-shaped parts, the thermoplastic material is injected from a plurality of different positions into the mold framework.

9. A method of manufacturing a display device including:
a display panel configured to display an image;
at least one support member configured to support the display panel; and
an adhesive member including an adhesive surface including an adhesive material,
the method comprising:
(a2) an adhesive member molding process of molding at least a part of the adhesive member at a predetermined place in a mold framework by injecting a thermoplastic material for the adhesive member that constitutes at least a part of the adhesive member into a part of the mold framework;
(b2) a support member molding process of molding the support member by injecting a thermoplastic material for the support member into a part in the mold framework excluding the predetermined place; and
(c2) an adhesion process of adhering the display panel to the adhesive surface of the adhesive member after the adhesive member molding process and the support member molding process.

10. A method of manufacturing a display device including:
a display panel configured to display an image;
at least one support member configured to support the display panel; and
an adhesive member including an adhesive base material and an adhesive surface formed on a front surface of the adhesive base material,
the method comprising:
(a3) a support member molding process of molding the support member including a recess part by injecting a thermoplastic material for the support member into a mold framework for the support member;
(b3) an adhesive base material molding process of molding the adhesive base material with at least a part being fixed in the recess part by injecting a thermoplastic material for the adhesive base material into a mold framework for the adhesive base material obtained by replacing at least a part of the mold framework for the support member;
(c3) an adhesive surface forming process of forming the adhesive surface by disposing an adhesive material on the front surface of the adhesive base material; and
(d3) an adhesion process of adhering the display panel to the adhesive surface.
